(19) United States
(12) Patent Application Publication
(10) Pub. No.: US 2016/0170575 A1
(43) Pub. Date: Jun. 16, 2016

(54) APPLICATION ACTIVATION METHOD AND APPARATUS AND ELECTRONIC EQUIPMENT

(71) Applicant: SONY CORPORATION, Tokyo (JP)

(72) Inventors: Bizhong YE, Beijing (CN); Yu ZHANG, Beijing (CN); Xiaofeng FAN, Beijing (CN); Shuai LIN, Beijing (CN); Zhangbin YIN, Beijing (CN); Wenhui XIA, Beijing (CN)

(73) Assignee: Sony Corporation

(21) Appl. No.: 14/394,411

(22) PCT Filed: Sep. 3, 2014
(86) PCT No.: PCT/IB2014/064207

§ 371 Date: Oct. 14, 2014

(30) Foreign Application Priority Data
Nov. 28, 2013 (CN) 201310625888.3

(51) Int. Cl. G06F 3/0482; G06F 3/0484; G06F 3/0481; G06F 17/30

(52) U.S. Cl. CPC G06F 3/0482; G06F 17/3051; G06F 3/04842; G06F 3/04817

(57) ABSTRACT

Embodiments of the present invention provide an application activation method and apparatus and electronic equipment. The activation method includes: determining one or more recommended application(s) according to information on practice of use of applications; and activating the one or more recommended application(s). With the embodiments of the present invention, many applications expected to be used need not to be looked for, thereby reducing a large quantity of repeated operations, and obtaining better user experience.

### TECHNICAL FIELD

The present invention relates to the field of communications, and in particular to an application activation method and apparatus and electronic equipment.

### CROSS REFERENCE TO RELATED APPLICATIONS

This application claims priority from Chinese patent application No. 201310625888.3, filed Nov. 28, 2013, the entire disclosure of which hereby is incorporated by reference.

### BACKGROUND ART

As the wide use of portable electronic equipment (such as a smart mobile phone, and a tablet computer, etc.), applications in the portable electronic equipment are also widely used by users. For example, a smart mobile phone may be installed with a large quantity of social applications, such as Facebook, and Wechat, etc., tool applications, such as Alarm, weather forecast, and calculator, etc., communications applications, such as Safari, and E-mail, etc., and entertainment applications, such as Sogou music, Baidu video, and radio, etc.

After an application is started up (or may also be referred to as being activated), it may be run at a foreground of the electronic equipment and may also be run at a background thereof. One application may be run only, and multiple applications may be run at the same time. For example, Sogou music may be activated to play video data while Facebook is run.

It should be noted that the above description of the background art is merely provided for clear and complete explanation of the present invention and for easy understanding by those skilled in the art. And it should not be understood that the above technical solution is known to those skilled in the art as it is described in the background art of the present invention.

### SUMMARY

Pursuant to the famous 80/20 rule, 20% very popular applications occupy our 80% time and attentions. This means that for each user, about 5-10 applications are frequently used. However, it was found by the inventors that in the relevant art, an application may only be started up according to an input of a user. In starting up a desired application each time, the user needs to look for and select the application desired to be used from a large quantity of applications, thereby resulting in a large quantity of repeated operations, and being not able to obtain better user experience.

Embodiments of the present invention provide an application activation method and apparatus and electronic equipment. When an application expected to be used needs to be started up, one or more recommended application(s) is(are) determined according to information on user habits for applications, thereby avoiding a need to excessively look for the applications expected to be used, reducing a large quantity of repeated operations, and obtaining better user experience.

According to a first aspect of the embodiments of the present invention, there is provided an application activation method, including:

determining one or more recommended application(s) according to information on a use habit for applications; and

activating the one or more recommended application(s).

According to a second aspect of the embodiments of the present invention, the one or more recommended application(s) is(are) determined according to the information on a use habit for applications in case of receiving triggering information inputted by a user, or in case of receiving triggering information transmitted by other equipment, or in case of satisfying a predefined condition.

According to a third aspect of the embodiments of the present invention, the predefined condition includes one piece of the following information or any combination thereof: detection information detected by a sensor reaching a predefined threshold value, reaching a predefined time, being positioned at a predefined location, a startup order of two or more applications, accessing to a predefined network and using a predefined ID card.

According to a fourth aspect of the embodiments of the present invention, after the determining one or more recommended application(s) according to the information on a use habit for applications, the activation method further includes:

displaying discriminatively icons of two or more applications;

receiving input information of the user for selecting an application from the two or more applications; and

starting up the selected application according to the input information.

According to a fifth aspect of the embodiments of the present invention, before the determining one or more recommended application(s) according to the information on a use habit for applications, the activation method further includes:

calculating respectively a recommendation degree of each of the two or more applications according to the information on a use habit; and

setting respectively a display attribute of each of the icons of the two or more applications according to the recommendation degree.

According to a sixth aspect of the embodiments of the present invention, the display attributes include one of the following attributes or any combination thereof: a display size, a display position, a display color, display brightness and a patterned shape.

According to a seventh aspect of the embodiments of the present invention, the activation method further includes:

counting information on the use of the user for the applications; and

generating the information on a use habit according to a result of the counting.

According to an eighth aspect of the embodiments of the present invention, after the activating the one or more recommended application(s), the activation method further includes:

updating the information on a use habit.

According to a ninth aspect of the embodiments of the present invention, the counting the information on the use of application of the user includes counting one piece of the following information or any combination thereof: time of using the application, a location of using the application, the number of times of using the application, a startup order of two or more applications, a network in using the application, and an ID card in using the application.

According to a tenth aspect of the embodiments of the present invention, the activation method further includes:

receiving the information on a use habit of the user for the applications.

According to an eleventh aspect of the embodiments of the present invention, the information on a use habit of the user for applications is formed by combining information on use habits of multiple user.

According to a twelfth aspect of the embodiments of the present invention, there is provided an application activation apparatus, including:

an application recommending unit configured to determine one or more recommended application(s) according to information on a use habit for applications; and

an application activation unit configured to activate the one or more recommended application(s).

According to a thirteenth aspect of the embodiments of the present invention, the application recommending unit determines the one or more recommended application(s) according to the information on a use habit for applications in case of receiving triggering information inputted by a user, or in case of receiving triggering information transmitted by other equipment, or in case of satisfying a predefined condition.

According to a fourteenth aspect of the embodiments of the present invention, the activation apparatus further includes:

an icon displaying unit configured to display discriminatively icons of two or more applications; and

a selection receiving unit configured to receive input information of the user for selecting an application from the two or more applications;

and the application activation unit is further configured to start up the selected application according to the input information.

According to a fifteenth aspect of the embodiments of the present invention, the activation apparatus further includes:

a recommendation degree calculating unit configured to calculate respectively a recommendation degree of each of the two or more applications according to the information on a use habit; and

an attribute setting unit configured to set respectively a display attribute of each of the icons of the two or more applications according to the recommendation degree.

According to a sixteenth aspect of the embodiments of the present invention, the activation apparatus further includes:

an information counting unit configured to count information on the use of the user for the applications; and

an information generating unit configured to generate the information on a use habit according to a result of the counting.

According to a seventeenth aspect of the embodiments of the present invention, the activation apparatus further includes:

an information receiving unit configured to receive the information on a use habit of the user for the applications.

According to an eighteenth aspect of the embodiments of the present invention, there is provided electronic equipment, including the application activation apparatus as described above.

According to a nineteenth aspect of the embodiments of the present invention, the electronic equipment includes a mobile terminal or wearable equipment.

According to a twentieth aspect of the embodiments of the present invention, the electronic equipment further includes one of the following sensors or any combination thereof: an acceleration sensor, a proximity sensor, a temperature sensor, a speed sensor, an atmospheric pressure sensor, a geomagnetic sensor, a deformation sensor, a humidity sensor, and a light sensor.

An advantage of the embodiments of the present invention resides in that when an application expected to be used needs to be started up, one or more recommended application(s) is(are) determined according to information on a use habit of a user for applications, thereby not needing to excessively look for the applications expected to be used, reducing a large quantity of repeated operations, and obtaining better user experience.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF DRAWINGS

The drawings are included to provide further understanding of the present invention, which constitute a part of the specification and illustrate the preferred embodiments of the present invention, and are used for setting forth the principles of the present invention together with the description. The same element is represented with the same reference number throughout the drawings.

In the drawings:

FIG. 1 is a flowchart of the application activation method of an embodiment of the present invention;

FIG. 2 is another flowchart of the application activation method of an embodiment of the present invention;

FIG. 3 is a further flowchart of the application activation method of an embodiment of the present invention;

FIG. 4 is still another flowchart of the application activation method of an embodiment of the present invention;

FIG. 5 is a schematic diagram of displaying an application of an embodiment of the present invention;

FIG. 6 is another schematic diagram of displaying an application of an embodiment of the present invention;

FIG. 7 is a further schematic diagram of displaying an application of an embodiment of the present invention;

FIG. 8 is a schematic diagram of the structure of the application activation apparatus of an embodiment of the present invention;

FIG. 9 is another schematic diagram of the structure of the application activation apparatus of an embodiment of the present invention;

FIG. 10 is a further schematic diagram of the structure of the application activation apparatus of an embodiment of the present invention;

FIG. 11 is still another schematic diagram of the structure of the application activation apparatus of an embodiment of the present invention; and

FIG. 12 is a block diagram of the systematic constitution of the electronic equipment of an embodiment of the present invention.

### DESCRIPTION OF EMBODIMENTS

The interchangeable terms “electronic apparatus” and “electronic device” include portable radio communication apparatus. The term “portable radio communication apparatus”, which hereinafter is referred to as a “mobile terminal”, “portable electronic device”, or “portable communication device”, includes all apparatuses such as mobile telephones, pagers, communicators, electronic organizers, personal digital assistants (PDAs), smartphones, portable communication devices or the like.

In the present application, embodiments of the invention are described primarily in the context of a portable electronic device in the form of a mobile telephone (also referred to as “a mobile phone”). However, it shall be appreciated that the invention is not limited to the context of a mobile telephone and may relate to any type of appropriate electronic apparatus, including a media player, a game device, a PDA and a computer, a digital video camera, a tablet computer, and wearable electronic equipment, etc

### Embodiment 1

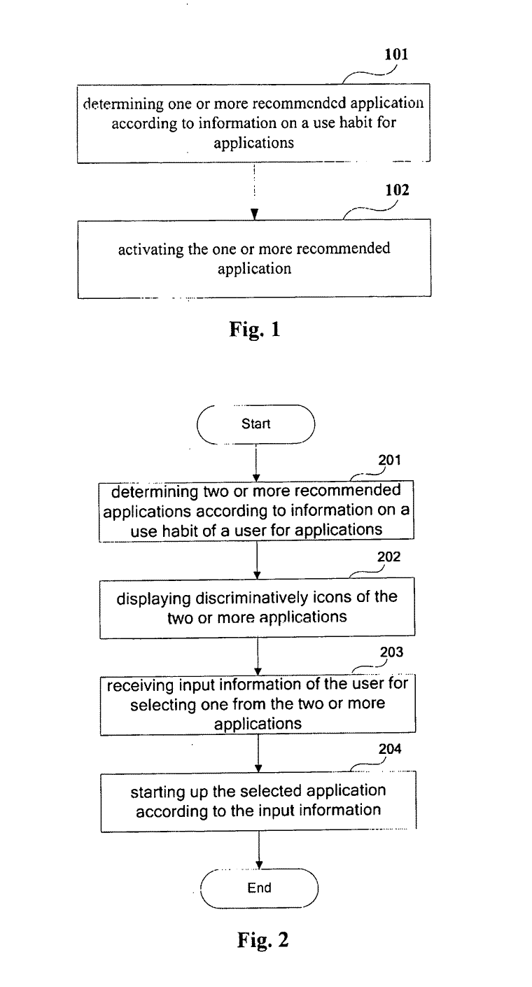

An embodiment of the present invention provides an application activation method. FIG. 1 is a flowchart of the application activation method of the embodiment of the present invention. As shown in FIG. 1, the activation method includes:

step 101: determining one or more recommended application(s) according to information on a use habit for applications; and

step 102: activating the one or more recommended application(s).

In this embodiment, starting up an application is also referred to as activating an application, and closing an application is also referred to as deactivating an application. The startup or close in the present invention should be understood in a broad sense, and should not be limited to simple On/Off.

In this embodiment, information on a use habit for applications may be formed by a user in operating applications in electronic equipment. The information on a use habit of a user for an application may be history information on using an application which may be generated by counting information on the use of the user for the application. For example, it may be time of using the application, a location of using the application, the number of times of using the application, by the user, a startup order of two or more applications, a network in using the application, or an ID card in using the application, etc. However, the present invention is not limited thereto, and particular information on a use habit may be determined as actually required.

In this embodiment, the information on a use habit for an application may also be formed by operating, by multiple users, an application in electronic equipment. The multiple users (such as members of a family) use one piece of electronic equipment together, thereby forming the information on the use habit.

In this embodiment, the information on a use habit for an application may also be formed by operating, by one piece of user equipment, applications in multiple pieces of electronic equipment. For example, one piece of user equipment may log in multiple smart mobile phones by using an account number and upload information on a use habit for applications in the multiple smart mobile phones to a network side by using a cloud computing technology. In using a smart mobile phone through the account number, the information on a use habit is downloaded.

In this embodiment, the information on a use habit for an application may be formed by operating, by multiple pieces of user equipment, applications in multiple pieces of electronic equipment. For example, the multiple pieces of user equipment may use a certain application in the smart mobile phones of their own, and then upload information on use habits of the multiple pieces of user equipment to a network side, thereby forming the information on a use habit through combining them.

And the information on a use habit may be classified. For example, it may be classified as per attributes of users, e.g. information on a use habit of Chinese people is 11, and information on a use habit of American people is 12, etc.; or information on a use habit of men is 21, and information on a use habit of women is 22; or information on a use habit of the young is 31, and information on a use habit of the middle aged is 32, etc.

Information on a use habit is only illustrated above. However, the present invention is not limited thereto, and particular information may be determined as actually required.

In this embodiment, step 101 may be executed in case of receiving triggering information inputted by a user, or in case of receiving triggering information transmitted by other equipment, or in case of satisfying a predefined condition, so as to determine the one or more recommended application(s) according to the information on a use habit of the user for applications;

wherein, the information inputted by the user may be taken as a triggering condition for determining the recommended application(s), and the triggering information inputted by the user may be information generated by clicking a return key, etc. by the user. Furthermore, communication information between two or more pieces of equipment may be taken as a triggering condition for determining the recommended application(s), and triggering information transmitted by other equipment may be received via Bluetooth, and Wifi, etc. Even further, a predefined condition may be taken as a triggering condition for determining the recommended application(s), and the predefined condition may include one piece of the following information or any combination thereof: detection information detected by a sensor reaching a predefined threshold value, reaching a predefined time, being positioned at a predefined location, closing a predefined application, accessing to a predefined network, and using a predefined ID card. However, the present invention is not limited thereto;

wherein, the sensor may be one of the following sensors or any combination thereof: an acceleration sensor, a proximity sensor, a temperature sensor, a speed sensor, an atmospheric pressure sensor, a geomagnetic sensor, a deformation sensor, a humidity sensor, and a light sensor. However, the present invention is not limited thereto.

In this embodiment, the information on a use habit of a user for an application may be directly related to a triggering condition. For example, if the information on a use habit of the user is time information, the recommended application(s) may be determined at the time or time period that the user is accustomed to; and if the information on a use habit of the user is location information, the recommended application(s) may be determined at a location or a location nearby (for example, within 20 meters near an office building) that the user is accustomed to.

In an implementation, the information on a use habit of a user for an application may be time information. For example, if the user is accustomed to starting up “Alarm”, electronic equipment may determine a recommended application as “Alarm” at 6:00 every morning; wherein, the icon of “Alarm” may be displayed on the screen of the electronic equipment for selection by the user, so as to start up “Alarm” after receiving input information selected by the user; and “Alarm” may also be directly started up. The time information may be acquired by a time module of the electronic equipment, and the relevant art may be referred to.

In another implementation, the information on a use habit of a user for an application may be location information. For example, if the user is accustomed to starting up “Sogou music” at home, the electronic equipment may determine a recommended application as “Sogou music” when the user come home after work everyday; wherein, the icon of “Sogou music” may be displayed on the screen of the electronic equipment for selection by the user, so as to start up “Sogou music” after receiving input information selected by the user; and “Sogou music” may also be directly started up. The location information may be acquired by a position module (such as a GPS module) of the electronic equipment, and the relevant art may be referred to.

In a further implementation, the information on a use habit of a user for an application may be a startup order of two or more applications, and a triggering condition for determining a recommended application may be an input of the user. For example, if the user is accustomed to start up “Alarm” and “radio” in order, the electronic equipment may determine that the recommended application is “radio” after “Alarm” is closed each time; wherein, the icon of “radio” may be displayed on the screen of the electronic equipment for selection by the user, so as to start up “radio” after receiving input information selected by the user; and “radio” may also be directly started up.

In still another implementation, the information on a use habit of a user for an application may be a network in using an application. For example, if the user is accustomed to start up “Baidu video” in the Wifi environment, the electronic equipment may determine that the recommended application is “Baidu video” when being connected to Wifi; wherein, the icon of “Baidu video” may be displayed on the screen of the electronic equipment for selection by the user, so as to start up “Baidu video” after receiving input information selected by the user; and “Baidu video” may also be directly started up.

In further still another implementation, the information on a use habit of a user for an application may be an ID card in using the application. For example, if the user is accustomed to using 3G data transmission and starting up “Baidu video” in using a SIM card of China Unicom, the electronic equipment may determine that the recommended application is “Baidu video” when the SIM card of China Unicom and 3G data transmission are used; wherein, the icon of “Baidu video” may be displayed on the screen of the electronic equipment for selection by the user, so as to start up “Baidu video” after receiving input information selected by the user; and “Baidu video” may also be directly started up.

In yet still another implementation, the triggering condition for determining a recommended application may be that detection information of the sensor is greater than/lower than a predefined threshold value. For example, when a temperature sensor of the electronic equipment detects that the temperature of the user is higher than the normal value, it may consider according to the information on a use habit that the user is doing exercises, and may determine an application recommended for calculating quantity of heat; or, for example, when a light sensor of the electronic equipment detects that the light is lower than a predefined threshold value, it may consider according to the information on practice of use that the user is having a rest, and may determine that the recommended application is “Sogou music”.

In yet further still another implementation, the triggering condition for determining a recommended application may be trigger information transmitted by other equipment. For example, the user is accustomed to using “iWatermelon” to estimate whether a watermelon is mature before enjoying a watermelon. When the user opens the door of a smart refrigerator and fetches out a watermelon (for example, the watermelon is placed at a predefined location, and the smart refrigerator may learn via a sensor whether the watermelon is placed or fetched out), the smart refrigerator may send out triggering information to an Apple ipad nearby that a watermelon is fetched out. After receiving the information, the Apple ipad may determine that the recommended application is “iWatermelon”, and the user may select this application to estimate whether the watermelon is mature.

It should noted that how to determine a recommended application according to information on a use habit of a user is illustrated above only; however, the present invention is not limited thereto, and multiple pieces of information on use habits may be combined to determine a recommended application. For example, time and location information may be combined to determine a recommended application, e.g. at home at 6:00 in the morning, electronic equipment may determine a recommended application as “Alarm”. However, the present invention is not limited thereto, and particular modes of implementation may be determined as actually required.

Recommending an application is illustrated above only; however, the present invention is not limited thereto, and two or more applications may be recommended. And as to recommending multiple applications, they may be displayed discriminatively for reference by the user in selection. A case of two or more applications shall be described below.

FIG. 2 is another flowchart of the application activation method of an embodiment of the present invention. As shown in FIG. 2, the activation method includes:

step 201: determining two or more recommended applications according to information on a use habit of a user for applications;

step 202: displaying discriminatively icons of the two or more applications;

step 203: receiving input information of the user for selecting an application from the two or more applications; and

step 204: starting up the selected application according to the input information.

In this embodiment, icons of two or more applications may be displayed discriminatively, so as to prompt the user to select. For example, a display size, a display position, a display color, display brightness and a patterned shape of the icons may be changed. However, the present invention is not limited thereto, and other attributes of the icons may be change for being displayed discriminatively.

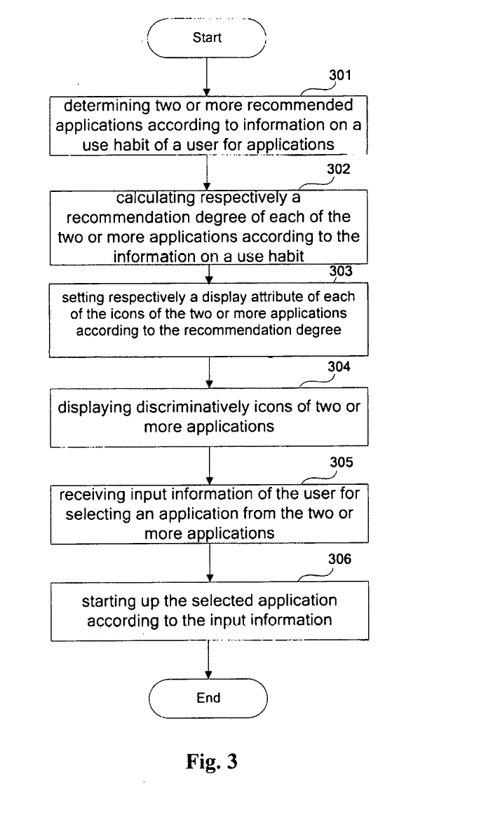

FIG. 3 is a further flowchart of the application activation method of an embodiment of the present invention. As shown in FIG. 3, the activation method includes:

step 301: determining two or more recommended applications according to information on a use habit of a user for applications;

step 302: calculating respectively a recommendation degree of each of the two or more applications according to the information on a use habit;

step 303: setting respectively a display attribute of each of the icons of the two or more applications according to the recommendation degree;

step 304: displaying discriminatively icons of two or more applications;

step 305: receiving input information of the user for selecting an application from the two or more applications; and

step 306: starting up the selected application according to the input information.

In this embodiment, the recommendation degree may be determined according to the information on a use habit. For example, if the user uses “Alarm” at 6:00 in the morning and uses for 70 times, while the user uses “radio” at 6:00 in the morning and uses for 30 times, the recommendation degree of “Alarm” may be determined as 70%, and that of “radio” may be determined as 30%. It should be noted that the present invention is not limited thereto, and particular manners of determining recommendation degree may be determined as actually required.

In this embodiment, the display attribute of the applications may be determined according to the recommendation degree. For example, the display size of the icon of the application with a higher recommendation degree may be set to be larger, and that of the icon of the application with a lower recommendation degree may be set to be smaller.

Or, the application with a higher recommendation degree may be displayed on the upper half of the screen, and the application with a lower recommendation degree may be displayed on the lower half of the screen. Or, if the electronic equipment is provided with a primary display screen and a secondary display screen, the application with a higher recommendation degree may be displayed on the primary display screen which is easy to be selected by the user, and the application with a lower recommendation degree may be displayed on the secondary display screen which is relatively not easy to be selected by the user.

In this embodiment, the information on a use habit of a user for applications may be obtained by counting the use habit of the user by the local equipment, or by receiving information transmitted by other terminal equipment, or by downloading from the network side. Following description is given taking that counting is performed in one piece of electronic equipment as an example.

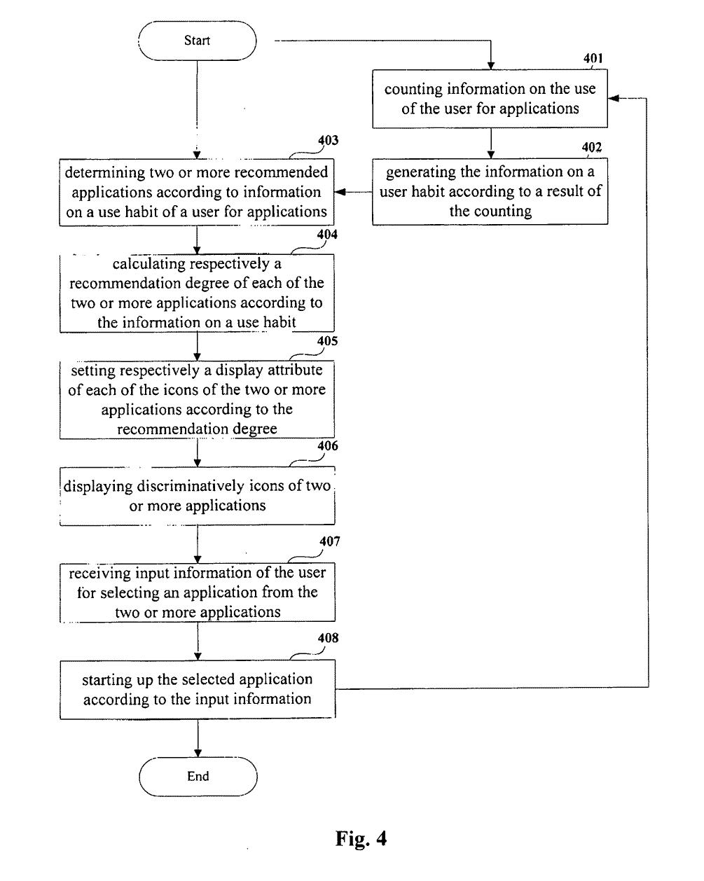

FIG. 4 is still another flowchart of the application activation method of an embodiment of the present invention. As shown in FIG. 4, the activation method includes:

step 401: counting information on the use of the user for applications;

step 402: generating the information on a user habit according to a result of the counting;

in this embodiment, history information may be counted first; and counting information on the use of the user for the applications may include counting one piece of the following information or any combination thereof: time of using the application, a location of using the application, the number of times of using the application, a startup order of two or more applications, a network in using the application, and an ID card in using the application; however, the present invention is not limited thereto, and particular counting information may be determined as actually required;

step 403: determining two or more recommended applications according to information on a use habit of a user for applications;

in this embodiment, the two or more recommended applications may be determined according to the information on a use habit of a user for applications in case of receiving triggering information inputted by the user, or in case of satisfying a predefined condition;

step 404: calculating respectively a recommendation degree of each of the two or more applications according to the information on a use habit;

step 405: setting respectively a display attribute of each of the icons of the two or more applications according to the recommendation degree;

step 406: displaying discriminatively icons of two or more applications;

step 407: receiving input information of the user for selecting an application from the two or more applications; and

step 408: starting up the selected application according to the input information.

In this embodiment, after activating the one or more recommended application(s), the activation method may further include: updating the information on a use habit. For example, step 401 may be executed again, so as to count the information on the use of the applications again, and update the information on a use habit according to a result of the counting.

It should be noted that the embodiments shown in FIGS. 2-4 are illustrative only. For example, in FIGS. 2-4, some of the steps may be omitted, orders of some of the steps may be changed, and some steps may be replaced by other modes of implementation. However, the present invention is not limited thereto, and particular modes of implementation may be determined as actually required.

The present invention shall be further described below by way of examples.

For example, if the user is accustomed to activating the application “Alarm” at 8:00, and activating the application “Walkman” or “FM Radio” between 8:00 and 8:20 to enjoy music, and is accustomed to activating the application “Facebook” or “Wechat” or “Gmail” after 8:20, the electronic equipment (such a smart mobile phone) may count in advance, so as to generate information on practice.

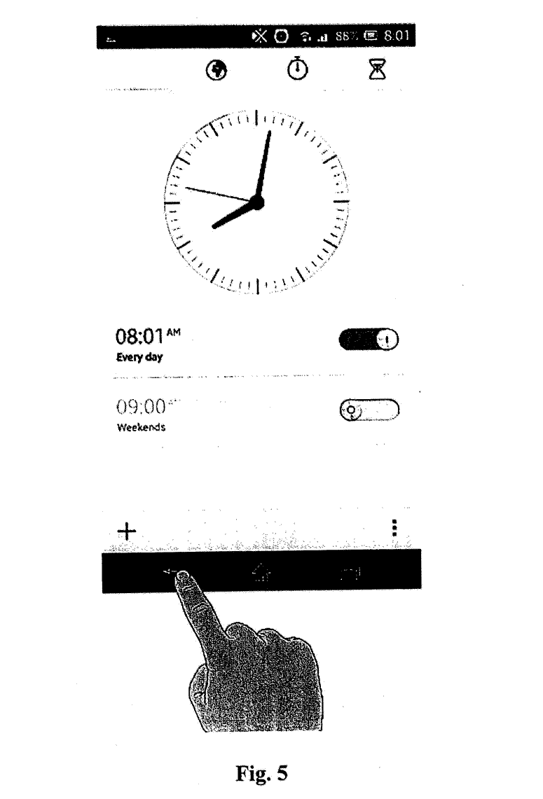

When predefined time information (8:00 in the morning) is satisfied, the smart mobile phone may determine that the recommended application is “Alarm”, and the application “Alarm” may be started up directly. FIG. 5 is a schematic diagram of displaying an application of an embodiment of the present invention. As shown in FIG. 5, the electronic equipment may directly start up the recommended application “Alarm” according the predefined time.

At 8:01, the user may click a return key to exit “Alarm”, so as to generate triggering information inputted by the user. At this moment, the smart mobile phone may determine according to the information on a use habit that the application sequentially triggered after “Alarm” is “Walkman” or “FM Radio”; and the electronic equipment may calculate according to the information on a use habit of the user that the recommendation degree of “Walkman” is 70%, and that of “FM Radio” is 30%.

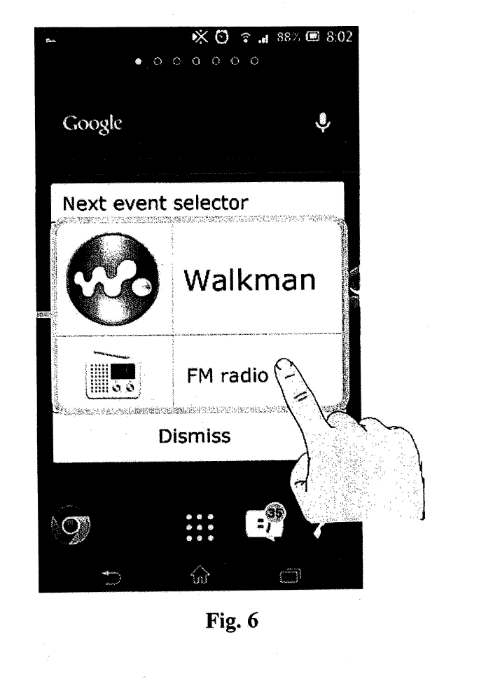

FIG. 6 is another schematic diagram of displaying an application of an embodiment of the present invention. As shown in FIG. 6, the smart mobile phone displays discriminatively “Walkman” and “FM Radio”, and sets the display size of “Walkman” as being greater than that of “FM Radio” according to the recommendation degree. After the user selects an application, such as “FM Radio”, the electronic equipment starts up application “FM Radio”.

Then, the user may click a return key to exit “FM Radio”, so as to generate triggering information inputted by the user. At this moment, the smart mobile phone may determine according to the information on a use habit that the application sequentially triggered after “FM Radio” is “Facebook” or “Wechat” or “Gmail”; and the electronic equipment may calculate according to the information on a use habit of the user that the recommendation degree of “Facebook” is 50%, that of “Wechat” is 30%, and that of “Gmail” is 20%.

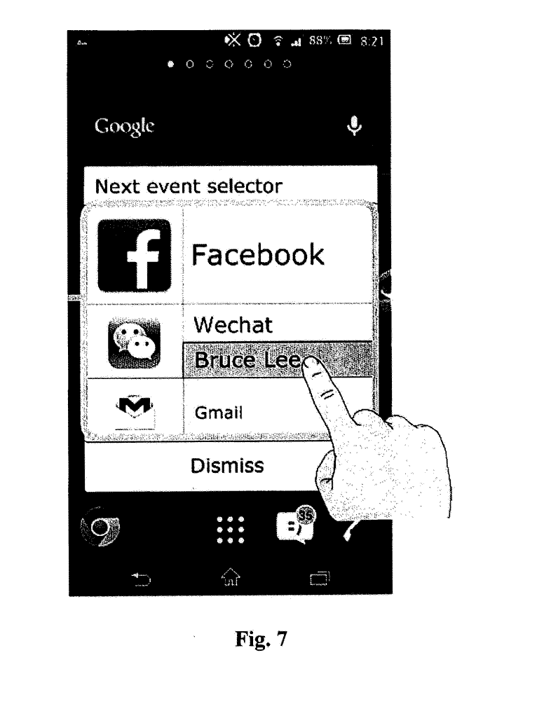

FIG. 7 is a further schematic diagram of displaying an application of an embodiment of the present invention. As shown in FIG. 7, the smart mobile phone displays discriminatively “Facebook”, “Wechat” and “Gmail”, and sets the display size of “Facebook” as being greater than that of “Wechat” and the display size of “Wechat” as being greater than that of “Gmail” according to the recommendation degrees. After the user selects an application, such as “Wechat”, the electronic equipment starts up application “Wechat”.

Furthermore, for an application of social software or an application of mail, if new update is contained, the update may be displayed to prompt the user. As shown in FIG. 7, if “Bruce Lee” updates a message in Wechat, the update may be displayed.

It can be seen from above embodiment that when an application expected to be used needs to be started up, one or more recommended applications are determined according to the information on a use habit of a user, thereby not needing to excessively look for applications expected to be used, reducing a large quantity of repeated operations, and obtaining better user experience.

### Embodiment 2

An embodiment of the present invention provides an application activation apparatus, corresponding to the application activation method of Embodiment 1; wherein, the parts identical to those in Embodiment 1 shall not be described any further.

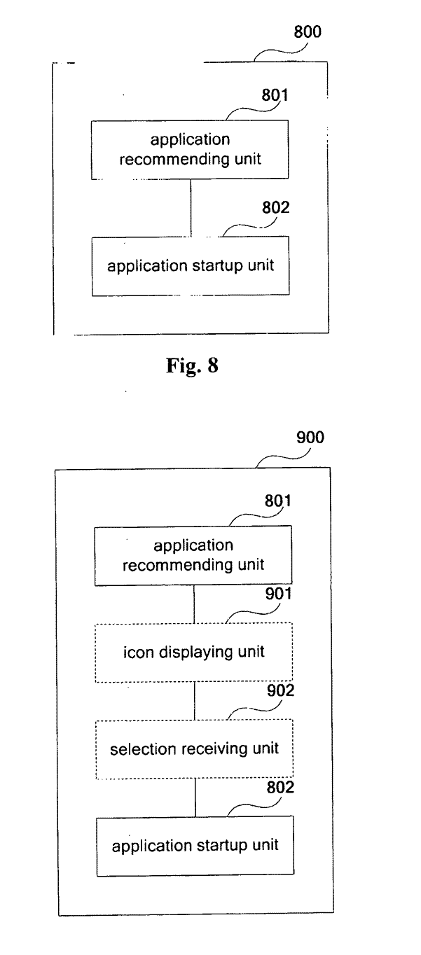

FIG. 8 is a schematic diagram of the structure of the application activation apparatus of an embodiment of the present invention. As shown in FIG. 8, the activation apparatus 800 includes: an application recommending unit 801 and an application activation unit 802; wherein, the application recommending unit 801 is configured to determine one or more recommended application(s) according to information on a use habit for applications, and the application activation unit 802 is configured to activate the one or more recommended application(s).

In this embodiment, the application recommending unit 801 may determine the one or more recommended application(s) according to the information on a use habit for applications in case of receiving triggering information inputted by the user, or in case of receiving triggering information transmitted by other equipment, or in case of satisfying a predefined condition.

In this embodiment, the predefined condition may include one piece of the following information or any combination thereof: detection information detected by a sensor reaching a predefined threshold value, reaching a predefined time, being positioned at a predefined location, closing a predefined application, accessing to a predefined network, and using a predefined ID card. However, the present invention is not limited thereto.

FIG. 9 is another schematic diagram of the structure of the application activation apparatus of an embodiment of the present invention. As shown in FIG. 9, the activation apparatus 900 includes: an application recommending unit 801 and an application activation unit 802, as described above.

As shown in FIG. 9, the activation apparatus 900 may further include an icon displaying unit 901 and a selection receiving unit 902; wherein, the icon displaying unit 901 is configured to display discriminatively icons of two or more applications, and the selection receiving unit 902 is configured to receive input information of the user for selecting an application from the two or more applications; and the application activation unit 802 is further configured to start up the selected application according to the input information.

In this embodiment, the display attributes include one of the following attributes or any combination thereof: a display size, a display position, a display color, display brightness and a patterned shape. However, the present invention is not limited thereto.

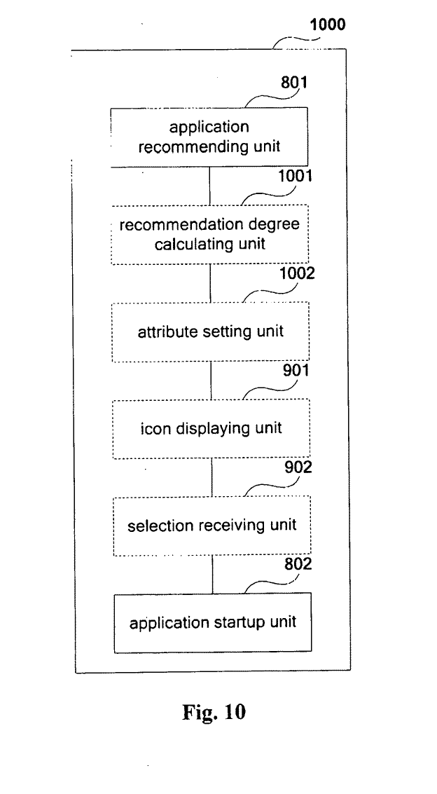

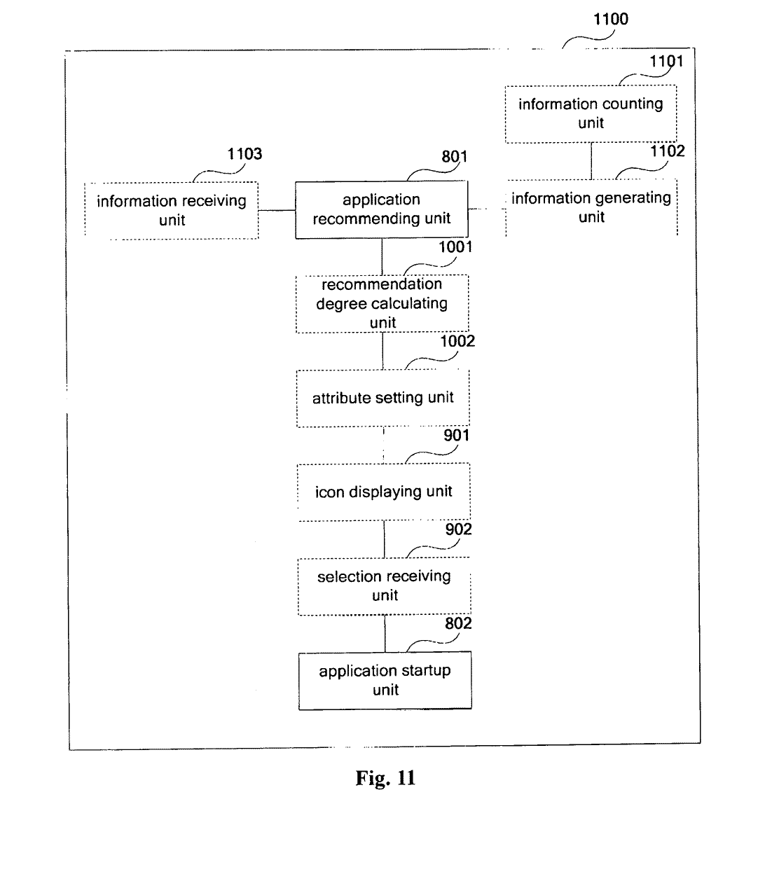

FIG. 10 is a further schematic diagram of the structure of the application activation apparatus of an embodiment of the present invention. As shown in FIG. 10, the activation apparatus 1000 includes: an application recommending unit 801, an application activation unit 802, an icon displaying unit 901 and a selection receiving unit 902, as described above.

As shown in FIG. 10, the startup apparatus 1000 may further include a recommendation degree calculating unit 1001 and an attribute setting unit 1002; wherein, the recommendation degree calculating unit 1001 is configured to calculate respectively a recommendation degree of each of the two or more applications according to the information on a use habit, and the attribute setting unit 1002 is configured to set respectively a display attribute of each of the icons of the two or more applications according to the recommendation degree.

FIG. 11 is still another schematic diagram of the structure of the application activation apparatus of an embodiment of the present invention. As shown in FIG. 11, the activation apparatus 1100 includes: an application recommending unit 801, an application activation unit 802, an icon displaying unit 901, a selection receiving unit 902, a recommendation degree calculating unit 1001 and an attribute setting unit 1002 as described above.

As shown in FIG. 11, the activation apparatus 1100 may further include an information counting unit 1101 and an information generating unit 1102; wherein, the information counting unit 1101 is configured to count information on the use of the user for applications, and the information generating unit 1102 is configured to generate the information on a use habit according to a result of the counting.

In this embodiment, the information counting unit 1101 and the information generating unit 1102 are further configured to update the information on a use habit after the application activation unit 802 activates one or more recommended applications.

As shown in FIG. 11, the activation apparatus 1100 may further include: an information receiving unit 1103 configured to receive the information on a use habit of the user. The information on a use habit may be downloaded from a network side, and information on a use habit transmitted by other equipment may also be received.

In this embodiment, counting the information on the use of the user for applications may include counting one piece of the following information or any combination thereof: time of using the application, a location of using the application, the number of times of using the application, a startup order of two or more applications, a network in using the application, and an ID card in using the application. However, the present invention is not limited thereto.

It can be seen from above embodiment that when an application expected to be used needs to be started up, one or more recommended applications are determined according to the information on a use habit of the user, thereby not needing to excessively look for applications expected to be used, reducing a large quantity of repeated operations, and obtaining better user experience.

### Embodiment 3

An embodiment of the present invention provides electronic equipment, including the application activation apparatus as described in Embodiment 2 above. And the electronic equipment may further include one of the following sensors or any combination thereof: an acceleration sensor, a proximity sensor, a temperature sensor, a speed sensor, an atmospheric pressure sensor, a geomagnetic sensor, a deformation sensor, a humidity sensor, and a light sensor. However, the present invention is not limited thereto. The electronic equipment may be a mobile terminal or wearable equipment. However, the present invention is not limited thereto.

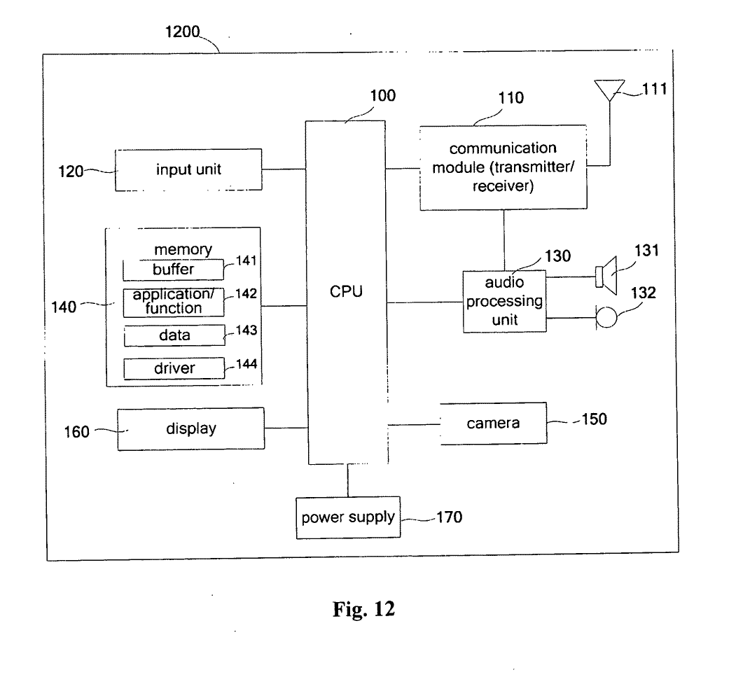

FIG. 12 is a block diagram of the systematic constitution of the electronic equipment 1200 of an embodiment of the present invention. As shown in FIG. 12, the electronic equipment 1200 may include a CPU 100 and a memory 140; wherein, the memory 140 is coupled to the CPU 100. It should be noted that this figure is illustrative only, and other types of structures may also be used for supplementing or replacing this structure, so as to implement the function of telecommunications or other functions.

In an implementation, the functions of the application activation apparatus may be integrated into the CPU 100; wherein, the CPU 100 may be configured to determine one or more recommended application(s) according to information on a use habit of a user for applications, and activate the one or more recommended application(s);

wherein, the one or more recommended application(s) may be determined according to the information on a use habit of a user for applications in case of receiving triggering information inputted by the user, or in case of receiving triggering information transmitted by other equipment, or in case of satisfying a predefined condition;

wherein, the predefined condition includes one piece of the following information or any combination thereof: detection information detected by a sensor reaching a predefined threshold value, reaching a predefined time, being positioned at a predefined location, a startup order of two or more applications, accessing to a predefined network and using a predefined ID card.

The CPU 100 may further be configured to, after the one or more recommended application(s) is(are) determined according to the information on a use habit of a user for applications, display discriminatively icons of two or more applications, receive input information of the user for selecting an application from the two or more applications, and start up the selected application according to the input information.

The CPU 100 may further be configured to, before the one or more recommended application(s) is(are) determined according to the information on a use habit for applications, calculate respectively a recommendation degree of each of the two or more applications according to the information on a use habit, and set respectively a display attribute of each of the icons of the two or more applications according to the recommendation degree;

wherein, the display attribute includes one of the following attributes or any combination thereof: a display size, a display position, a display color, display brightness and a patterned shape.

The CPU 100 may further be configured to count information on the use of the user for applications, and generate the information on a use habit according to a result of the counting.

The CPU 100 may further be configured to, after the one or more recommended application(s) is(are) activated, update the information on a use habit;

wherein, counting the information on the use of the user for applications includes counting one piece of the following information or any combination thereof: time of using the application, a location of using the application, the number of times of using the application, a startup order of two or more applications, a network in using the application, and an ID card in using the application.

In another implementation, the application activation apparatus may be provided being separated from the CPU 100. For example, the application activation apparatus may be set as a chip connected to the CPU 100, and the functions of the application activation apparatus may be carried out under the control of the CPU 100.

As shown in FIG. 12, the electronic equipment 1200 may further include a communication module 110, an input unit 120, an audio processing unit 130, a display 160, and a power supply 170. It should be noted that the electronic equipment 1200 does not necessarily include all the parts shown in FIG. 12. Furthermore, the electronic equipment 1200 may include other parts than those shown in FIG. 12, and the relevant art may be referred to.

As shown in FIG. 12, the CPU 100 (also referred to as a controller or an operational control, which may include a microprocessor or other processing devices and/or logic devices) receives input and controls each part and operation of the electronic equipment 1200;

wherein, for example, the memory 140 may be one or more of a buffer memory, a flash memory, a hard disk drive, a mobile medium, a volatile memory, a non-volatile memory, or other suitable devices, which may store information on failure, and furthermore, may store a program executing related information. And the CPU 100 may execute the program stored in the memory 140, so as to perform information storage or processing, etc.

The input unit 120 provides input to the CPU 100. The input unit 120 may be for example a key or touch input device. The camera 150 is used to take image data and provide the taken image data to the CPU 100 for use in a conventional manner, for example, for storage, and transmission, etc. The power supply 170 is used to supply power to the electronic equipment 1200. And the display 160 is used to display the objects of display, such as images, and characters, etc. The display may be for example an LCD display, but it is not limited thereto.

The memory 140 may be a solid memory, such as a read-only memory (ROM), a random access memory (RAM), and a SIM card, etc., and may also be such a memory that stores information when the power is interrupted, may be optionally erased and provided with more data. Examples of such a memory are sometimes referred to as an EPROM, etc. The memory 140 may also be certain other types of devices. The memory 140 includes a buffer memory 141 (sometimes referred to as a buffer). The memory 140 may include an application/function storing portion 142 used to store application programs and function programs, or to execute the flow of the operation of the electronic equipment 1200 via the CPU 100.

The memory 140 may further include a data storing portion 143 used to store data, such as a contact person, digital data, pictures, voices and/or any other data used by the electronic equipment. A driver storing portion 144 of the memory 140 may include various types of drivers of the electronic equipment for the communication function and/or for executing other functions (such as application of message transmission, and application of directory, etc.) of the electronic equipment.

The communication module 110 is a transmitter/receiver 110 transmitting and receiving signals via an antenna 111. The communication module (transmitter/receiver) 110 is coupled to the CPU 100 to provide input signals and receive output signals, this being similar to the case in a conventional mobile phone.

A plurality of communication modules 110 may be provided in the same user equipment for various communication technologies, such a cellular network module, a Bluetooth module, and/or wireless local network module, etc. The communication module (transmitter/receiver) 110 is also coupled to a loudspeaker 131 and a microphone 132 via the audio processing unit 130, for providing audio output via the loudspeaker 131, and receiving audio input from the microphone 132, so as to execute conventional telecommunications functions. The audio processing unit 130 may further include any suitable buffer, decoder, and amplifier, etc. Furthermore, the audio processing unit 130 is coupled to the CPU 100, so that voice recording is enabled in the native device, and the voices stored in the native device are enabled to be played via the loudspeaker 131.

An embodiment of the present invention further provides a computer-readable program, wherein when the program is executed in electronic equipment, the program enables the computer to carry out the application activation method as described in Embodiment 1 in the electronic equipment.

An embodiment of the present invention further provides a storage medium in which a computer-readable program is stored, wherein the computer-readable program enables the computer to carry out the application activation method as described in Embodiment 1 in electronic equipment.

The preferred embodiments of the present invention are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, units, segments or parts for realizing the codes of executable instructions of the steps in specific logic functions or processes, and that the scope of the preferred embodiments of the present invention include other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present invention. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present invention by using the devices.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. An application activation method, comprising:
determining one or more recommended application(s) according to information on a use habit for applications; and
activating the one or more recommended application(s).

2. The activation method according to claim 1, wherein the one or more recommended application(s) is(are) determined according to the information on a use habit for applications in case of receiving triggering information inputted by a user, or in case of receiving triggering information transmitted by other equipment, or in case of satisfying a predefined condition.

3. The activation method according to claim 1, wherein the predefined condition comprises one piece of the following information or any combination thereof: detection information detected by a sensor reaching a predefined threshold value, reaching a predefined time, being positioned at a predefined location, a startup order of two or more applications, accessing to a predefined network and using a predefined ID card.

4. The activation method according to claim 1, wherein after the determining one or more recommended application(s) according to the information on a use habit for applications, the activation method further comprises:
displaying discriminatively icons of two or more applications;
receiving input information of the user for selecting an application from the two or more applications; and
starting up the selected application according to the input information.

5. The activation method according to claim 1, wherein before the determining the one or more recommended application(s) according to the information on a use habit for applications, the activation method further comprises:
calculating respectively a recommendation degree of each of the two or more applications according to the information on a use habit; and
setting respectively a display attribute of each of the icons of the two or more applications according to the recommendation degree.

6. The activation method according to claim 5, wherein the display attribute comprises one of the following attributes or any combination thereof: a display size, a display position, a display color, display brightness and a patterned shape.

7. The activation method according to claim 1, wherein the activation method further comprises:
counting information on the use of the user for the applications; and
generating the information on a use habit according to a result of the counting.

8. The activation method according to claim 1, wherein after the activating the one or more recommended application(s), the activation method further comprises:
updating the information on a use habit.

9. The activation method according to claim 7, wherein the counting the information on use of the user for the applications comprises counting one piece of the following information or any combination thereof: time of using the application, a location of using the application, the number of times of using the application, a startup order of two or more applications, a network in using the application, and an ID card in using the application.

10. The activation method according to claim 1, wherein the activation method further comprises:
receiving the information on a use habit of the user.

11. The activation method according to claim 1, wherein the information on a use habit of the user is formed by combining information on use habits of multiple users.

12. An application activation apparatus, comprising:
an application recommending unit configured to determine one or more recommended application(s) according to information on a use habit for applications; and
an application activation unit configured to activate the one or more recommended application(s).

13. The activation apparatus according to claim 12, wherein the application recommending unit determines the one or more recommended application(s) according to the information on a use habit of applications in case of receiving triggering information inputted by a user, or in case of receiving triggering information transmitted by other equipment, or in case of satisfying a predefined condition.

14. The activation apparatus according to claim 12, wherein the activation apparatus further comprises:
an icon displaying unit configured to display discriminatively icons of two or more applications; and
a selection receiving unit configured to receive input information of the user for selecting an application from the two or more applications; and
the application activation unit is further configured to start up the selected application according to the input information.

15. The activation apparatus according to claim 14, wherein the activation apparatus further comprises:
a recommendation degree calculating unit configured to calculate respectively a recommendation degree of each of the two or more applications according to the information on a use habit; and
an attribute setting unit configured to set respectively a display attribute of each of the icons of the two or more applications according to the recommendation degree.

16. The activation apparatus according to claim 12, wherein the activation apparatus further comprises:
an information counting unit configured to count information on the use of the user for the applications; and
an information generating unit configured to generate the information on a use habit according to a result of the counting.

17. The activation apparatus according to claim 12, wherein the activation apparatus further comprises:
an information receiving unit configured to receive the information on a use habit of the user.

18. Electronic equipment, comprising the application activation apparatus as claimed in claim 12.

19. The electronic equipment according to claim 18, wherein the electronic equipment comprises a mobile terminal or wearable equipment.

20. The electronic equipment according to claim 18, wherein the electronic equipment further comprises one of the following sensors or any combination thereof: an acceleration sensor, a proximity sensor, a temperature sensor, a speed sensor, an atmospheric pressure sensor, a geomagnetic sensor, a deformation sensor, a humidity sensor, and a light sensor.
